(19) United States
(12) Patent Application Publication
(10) Pub. No.: US 2026/0003671 A1
(43) Pub. Date: Jan. 1, 2026

(54) SYSTEM AND METHOD FOR AUTOMATED IDENTIFICATION AND INFERENCE OF CHARACTERISTICS OF ENTITIES

(71) Applicant: AMIT KUMAR GAUTAM, PUNE (IN)

(72) Inventor: AMIT KUMAR GAUTAM, PUNE (IN)

(73) Assignee: ABLUVA PRIVATE LIMITED, PUNE (IN)

(21) Appl. No.: 19/241,426

(22) Filed: Jun. 18, 2025

Related U.S. Application Data
(60) Provisional application No. 63/664,741, filed on Jun. 27, 2024.

(51) Int. Cl. G06F 9/48

(52) U.S. Cl. CPC G06F 9/4881

(57) ABSTRACT

A method for managing automation tasks for a subject entity is disclosed. The method includes identifying context parameters associated with the subject entity among a set of entities. The context parameters comprise a hierarchical context parameter, a parallel context parameter, or a self-context parameter. Further, the method includes inferring characteristics of the subject entity based on the identified context parameters and relationships between the subject entity and one or more other entities within the set of entities. The characteristics indicate an operational and contextual attributes of the subject entity. Furthermore, the method includes assigning entity tags to the subject entity based on the characteristics. The entity tags indicate a representation of the subject entity's contextual and operational attributes. Furthermore, the method includes triggering an automation task associated with the subject entity based on the assigned entity tags.

### FIELD OF THE INVENTION

The present disclosure relates to data discovery. More particularly, the present disclosure relates to a system and a method for automated identification and inference of characteristics of one or more entities.

### BACKGROUND

In the field of data management and security, the automation of tasks related to entity characterization and sensitivity discovery has become increasingly critical. As the volume and complexity of data continue to grow, traditional manual methods for identifying and classifying entities have become impractical and prone to errors.

The identification of sensitive data, or the discovery of entity characteristics more broadly, also known as entity tagging, plays a critical role in governance and compliance with regulatory frameworks. This process is essential for safeguarding intellectual property, mitigating insider threats, building customer trust, and overall risk management in business operations. Moreover, automated entity tagging facilitates the automation of diverse tasks within data management, security, and optimization domains. These tasks include automatic sensitive data filtering, migration of critical processes to reliable systems, and grouping similar tasks for efficiency.

Existing systems often struggle to keep pace with evolving data environments, where entities interact dynamically across diverse contexts. Efforts to automate data management tasks, such as access control, data lifecycle management, and security monitoring, rely heavily on accurate and efficient entity characterization.

Prior art includes systems that leverage contextual information to infer entity characteristics, but many of these systems are limited in their scope and efficiency. Traditional methods of automated tag identification in information systems rely on two primary approaches: pattern matching and machine learning-based techniques. Pattern matching involves searching for predefined regular expressions or unique identifiers that signify specific characteristics such as data sensitivity (e.g., credit card numbers, Social Security numbers, etc.). Alternatively, machine learning models are trained on annotated datasets to recognize patterns associated with particular characteristics. However, both methodologies share a common limitation of requiring prior knowledge of entity structures and characteristics. This limitation restricts their effectiveness in new domains or with entity types not encountered during training or pattern definition phases. Consequently, these methods may encounter challenges when identifying characteristics in new scenarios or unconventional entity formats.

There remains a need for a comprehensive and adaptable system that can automate tasks based on entity attributes, ensuring optimal data security and operational efficiency by leveraging advanced inference techniques and contextual analysis.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for managing automation tasks for a subject entity is disclosed. The method includes identifying a plurality of context parameters associated with the subject entity among a set of entities. The plurality of context parameters comprises at least one of a hierarchical context parameter, a parallel context parameter, or a self-context parameter. Furthermore, the method includes inferring one or more characteristics of the subject entity based on the identified context parameters and relationships between the subject entity and one or more other entities within the set of entities The one or more characteristics indicate operational and contextual attributes of the subject entity. Furthermore, the method includes assigning one or more entity tags to the subject entity based on the inferred one or more characteristics. The one or more entity tags indicate a representation of the subject entity's contextual and operational attributes. Furthermore, the method includes triggering at least one automation task associated with the subject entity based on the assigned one or more entity tags.

According to an embodiment of the present disclosure, a system for managing automation tasks for a subject entity is disclosed. The system includes a memory and at least one processor in communication with the memory. The at least one processor is configured to identify a plurality of context parameters associated with the subject entity among a set of entities. The plurality of context parameters comprises at least one of a hierarchical context parameter, a parallel context parameter, or a self-context parameter. Further, the at least one processor is configured to infer one or more characteristics of the subject entity based on the identified plurality of context parameters and relationships between the subject entity and one or more other entities within the set of entities. The one or more characteristics indicate an operational and contextual attributes of the subject entity. Furthermore, the at least one processor is configured to assign one or more entity tags to the subject entity based on the inferred one or more characteristics. The one or more entity tags indicate a representation of the subject entity's contextual and operational attributes. Furthermore, the at least one processor is configured to trigger at least one automation task associated with the subject entity based on the assigned one or more entity tags.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting to its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an environment comprising a system for automated identification and inference of characteristics of one or more entities, in accordance with an embodiment of the present disclosure;

FIG. 2 illustrates a block diagram of the system for automated identification and inference of characteristics of one or more entities, in accordance with an embodiment of the present disclosure;

FIG. 3 illustrates a process flow depicting operations among a set of modules of the system, in accordance with an embodiment of the present disclosure; and

FIG. 4 illustrates a process flow depicting a method associated with the system for automated identification and inference of characteristics of one or more entities, in accordance with an embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

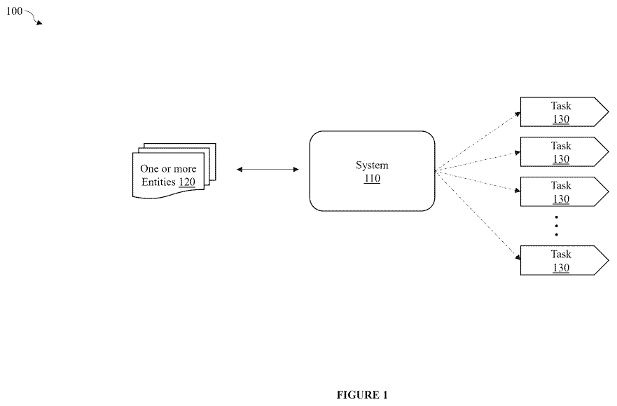

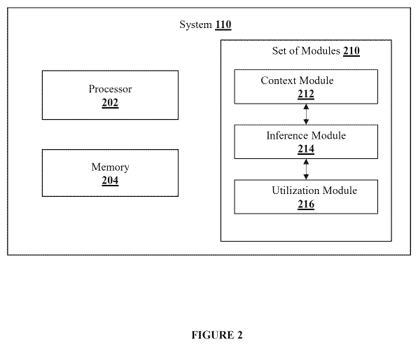

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates a block diagram of an environment 100 comprising a system 110 for automated identification and inference of characteristics of one or more entities 120. The system 110 may be communicably coupled with the one or more entities 120. In an embodiment, the one or more entities 120, also referred to as the set of entities 120, may be associated with one or more electronic devices. In an embodiment, the one or more entities 120 may be associated with one or more datastores.

The system 110 may be configured to identify context associated with the one or more entities 120 and infer characteristics of the one or more entities 120. Further, the system 110 may be configured to facilitate the automation of various tasks 130 based on the inferred characteristics of the one or more entities 120. The various tasks 130 may include, in non-limiting examples, access control, data life cycle, attack surface reduction, scoring and ranking, clustering and classification, alerting, and the like. The system 110 thus facilitates the provision of entity classification and sensitivity discovery engine that can be utilized for various data and security tasks, as will be described in detail further below.

In an embodiment, the system 110 may be implemented in conjunction with one or more electronic devices. For instance, the system 110 may be integrated within an electronic device. In another embodiment, the system 110 may be implemented in a cloud-based server. In such a scenario, the system 110 may be in communication with an electronic device via a suitable communication network. The network may include a wireless network or a wired network. For example, the network corresponds to Wi-Fi, cellular networks such as 3G, 4G, 5G, pre-5G, 6G network, or any other wireless communication network.

In an embodiment, the system 110 illustrated in FIG. 1 is configured to operate on a subject entity selected from the set of entities 120. In an example, the subject entity may be a data element, the one or more electronic devices, or any system component understood as part of the set of entities 120 within the scope of the present disclosure. Further, the system 110 is configured to identify a plurality of context parameters (referred to as context parameters for the sake of brevity) associated with the subject entity. The context parameters may include a hierarchical context parameter, a parallel context parameter, or a self-context parameter. In an example, the context parameters are identified based on analyzing structural, behavioral, and intrinsic associations of the subject entity within the environment 100, such as interactions with the set of entities 120. For instance, the hierarchical context may be identified based on analyzing semantic layering or containerization relationships (e.g., namespace, report-view-table hierarchy), the parallel context parameter may be identified based on examining access logs, query joins, or co-usage events among peer entities, and the self-context parameter may be extracted from metadata such as encryption level, ownership attributes, or access history intrinsic to the subject entity.

In an embodiment, upon identifying these context parameters, the system 110 is configured to infer one or more characteristics of the subject entity based on contextual relationships between the subject entity and one or more other entities within the set of entities 120. The one or more characteristics (also referred to as characteristics for the sake of brevity) correspond to an operational and contextual attribute of the subject entity. For instance, based on the hierarchical context parameter indicating that the subject entity is part of a business intelligence report, the system 110 may infer that the subject entity is business-critical or subject to heightened compliance requirements. Similarly, based on the parallel context parameter, such as frequent co-occurrence with other entities labeled as sensitive, the system 110 may infer a high sensitivity level for the subject entity. Additionally, based on the self-context parameter like encryption level, ownership metadata, or access frequency, the system 110 may infer the characteristics such as restricted access scope, volatility, or relevance within a workflow.

In the embodiment, inferring the characteristics may be performed using a graphical structure internally maintained within the system 110. Further, the set of entities 120 may be represented as nodes in the graphical structure and contextual associations among the set of entities 120 as weighted edges. In an example, the characteristics inferred may include sensitivity, volatility, relevance, and other operational attributes that are not directly encoded in the subject entity but become apparent through relational reasoning across the set of entities 120.

In an embodiment, the system 110 is configured to assign one or more entity tags (also referred to as entity tags for the sake of brevity) to the subject entity based on the inferred characteristics. The entity tags may correspond to abstractions that semantically classify the subject entity and may be used for policy enforcement, classification, or alert prioritization. Thus, entity tags are representations of the subject entity's contextual and operational attributes. In an example, the entity tags may include, labels such as “Confidential”, “High-Access Frequency”, or “Restricted Storage”, based on the inferred characteristics.

In an embodiment, the system 110 is configured to trigger at least one automation task (also referred to as automation task 130 or task 130 for the sake of brevity). The automation task 130 is executed dynamically based on the entity tags and may include for instance, applying fine-grained access controls, enforcing data retention rules, isolating entities from high-risk network zones, generating alerts for abnormal access, or adjusting the classification of linked entities. In the embodiment, the system 110 may continuously monitor the environment 100 and update the entity tags in real time, enabling ongoing automation and governance across a dynamic dataset or enterprise system.

In an example scenario, the system 110 may be implemented within an enterprise environment with multiple business intelligence (BI) reports, data tables, and user activity logs stored within a cloud-based data platform. In the example scenario, the subject entity selected from among the set of entities 120 is a data table named “Billing Records.” It is to be understood, however, that the system 110 is equally applicable where the subject entity is an electronic device, service node, dataflow component, or any other system entity encompassed within the set of entities 120. In the example, the subject entity, labelled as the “Billing Records” is evaluated by the system 110 for security, governance, and automation task.

In the example scenario, the system 110 identifies the context parameters for the subject entity “Billing Records”. Further, the hierarchical context parameter is derived based on identifying that “Billing Records” is consumed by a “Revenue Dashboard” report and defined in a data warehouse under a “HealthcareBilling” semantic layer. Similarly, the parallel context parameter is identified through access logs and query joins that show the data table (“Billing Records”) is frequently accessed alongside another data table named “Patient Diagnose.” Further, the self-context parameter is identified from the metadata such as a “highly sensitive” label in the data table's annotations, and ownership metadata linking it to the revenue department.

Thus, in an advantageous aspect, the identification of the contextual parameters ensures that the system 110 understands not just the data table in isolation, but also the significance of the data table in business processes, peer data structures, and inherent configurations. Therefore, the system 110 improves inference accuracy and reduces false positives or negatives in classification.

Further, in the example scenario, based on the identified contextual parameters, the system 110 models the relationships, preferably the contextual relationships as the graphical structure and infers characteristics. For instance, based on the role of the data table (Billing Record) in the revenue dashboard and relation with the other data table “Patient Diagnose,” the data table possesses characteristics such as “sensitive” and “health-related” characteristics. Furthermore, the encryption level and ownership metadata of the data table “Billing Record” may to characteristics such as “restricted access required” and “ownership by the revenue department.”

Thus, in an advantageous aspect, the graphical structure representing the contextual reasoning and weighted edges for graph traversal enables the system 110 to infer attributes such as domain relevance or sensitivity without requiring human intervention. Therefore, the system 110 advantageously supports intelligent automation and dynamic decision-making.

Furthermore, in the example scenario, the characteristics, the system 110 assigns the entity tags to the data table “Billing Records,” such as sensitive, finance-governed, health data, encrypted.

Thus, in an advantageous aspect, the entity tags act as standardized, labels acting as reference for the system 110. Therefore, the system 110 advantageously dissociates human-defined business logic from low-level metadata, enabling policy abstraction.

Furthermore, in the example scenario, the system 110 triggers automation task 130 based on the entity tags. In the example scenario, the system 110 may manage access control based on automatically restricting access to only users with “revenue” and “healthcare” roles in the organization and revoke access from unrelated teams. Similarly, in the example scenario, the system 110 may trigger a policy that archives the data table after a few months of inactivity, based on data governance rules for sensitive (as the entity tag) financial data. Similarly, in the example scenario, the system 110 may send an automated alert to notify security teams if the table is accessed outside of business hours.

Thus, in an advantageous aspect, the triggering of the automation task 130 based on the inferred characteristics and the assigned entity tags, the system 110 creates a self-adjusting, policy-aware environment that dynamically adapts to the subject entity behavior and context thereby reducing human workload, enhancing data security, and enforcing compliance without explicit scripting.

FIG. 2 illustrates a block diagram of the system 110 depicted in FIG. 1. The system 110 includes one or more processors 202 (alternatively referred to as a ‘processor 202’) and a memory 204. As a non-limiting example, the one or more processors 202 are a single processing unit or a set of units each including multiple computing units. The one or more processors 202 are implemented as one or more microprocessors, microcomputers, microcontrollers, digital signal processors, central processing units, state machines, logic circuitries, and/or any devices that manipulate signals based on operational instructions (computer-readable instructions) stored in the memory 204. Among other capabilities, the one or more processors 202 are configured to fetch and execute computer-readable instructions and data stored in the memory 204. The one or more processors 202 include one or a plurality of processors. The plurality of processors are further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors control the processing of the input data in accordance with a predefined operating rule or an artificial intelligence (AI) model stored in the memory 204. The predefined operating rule or the AI model is provided through training or learning.

The one or more processors 202 are disposed in communication with one or more input/output (I/O) devices via an Input/Output (I/O) interface. The I/O interface employs communication code-division multiple access (CDMA), high-speed packet access (HSPA+), global system for mobile communications (GSM), long-term evolution (LTE), WiMax, or the like, etc. In another embodiment of the present invention, the I/O interface employs ethernet, industrial wireless Local Area Network (LAN), Process Field Bus (PROFIBUS), Actuator Sensor (AS) Interface, and the like.

In some embodiments, the memory 204 is communicatively coupled to the one or more processors 202. The memory 204 is configured to store instructions executable by the one or more processors 202. In one embodiment, the memory 204 communicates via a bus within the system 110. The memory 204 includes, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the one or more processors 202.

In alternative examples, the memory 204 is separate from the one or more processors 202 such as a cache memory of a processor, the system memory, or other memory. The memory 204 is an external storage device or a datastore for storing data. The memory 204 is operable to store instructions executable by the one or more processors 202. The functions, acts or tasks illustrated in the figures or described are performed by the programmed processor for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies include multiprocessing, multitasking, parallel processing, and the like.

The memory 204 may include an operating system for performing one or more tasks of the system 110, as performed by a generic operating system in the communications domain. In one embodiment, the memory 204 is configured to store the information as required by the one or more processors 202 to perform one or more functions for validating accessors based on data access language patterns and query execution analysis.

The system 110 further comprises a set of modules 210. The processor 202 may be configured to perform designated functions in conjunction with the memory 204 and the set of modules 210. In some embodiments, the set of modules 210 may be included within the memory 204. In some embodiments, the set of modules 210 may include a set of instructions that may be executed to cause the system 110, in particular, the processor 202, to perform any one or more of the methods disclosed herein. The set of modules 210 in conjunction with the processor 202 may be configured to perform the steps of the present disclosure using the data stored in the memory 204, as discussed throughout this disclosure. In an embodiment, each of the set of modules 210 may be software modules within the memory 204. In an embodiment, each of the set of modules 210 may be hardware units that may be outside the memory 204.

In an embodiment, the set of modules 210 may include a context module 212, an inference module 214, and a utilization module 216. The context module 212, the inference module 214, and the utilization module 216 may be in communication with each other.

In an embodiment, the set of modules 210 may be a part of the processor 202. In another embodiment, the processor 202 may be configured to perform the functions of the set of modules 210.

In an embodiment, the context module 212 is configured to identify the context parameters associated with the subject entity among the set of entities 120.

In an embodiment, the inference module 214 is configured to infer the characteristics of the subject entity based on the identified plurality of context parameters and relationships between the subject entity and the one or more other entities within the set of entities 120.

Further, in an embodiment, the inference module 214 is configured to assign the entity tags to the subject entity based on the inferred characteristics.

In an embodiment, the utilization module 216 is configured to the automation task associated with the subject entity based on the entity tags.

The working for the set of modules 210 is further explained in detail in the following paragraphs.

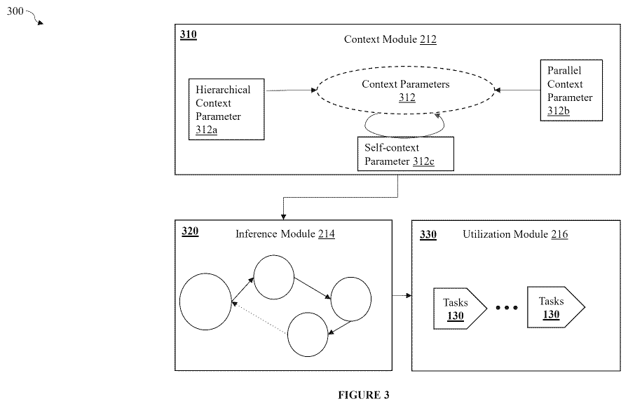

FIG. 3 illustrates a process flow 300 depicting operations among the set of modules 210 of the system 110. The set of modules 210 may include the context module 212, the inference module 214, and the utilization module 216. Details of the invention will now be described collectively with FIGS. 1-3.

At block 310, the processor 202 in conjunction with the context module 212 may be configured to identify the context parameters 312 in order to establish relationships among the set of entities 120. Using the context parameters 312, or a combination thereof, the characteristics associated with the set of entities 120 can be inferred.

In an embodiment, the processor 202 in conjunction with the context module 212 may be configured to obtain system data associated with the subject entity. In an example, the system data includes metadata, access logs, data flow traces, source code structures, visual design artifacts, ownership records, encryption policies, and semantic labels.

In an embodiment, the context parameters 312 may include the hierarchical context parameter 312a. In the hierarchical context parameter 312a, higher level concepts and/or structures with constituent lower-level entities and/or concepts may be examined. For instance, policies, access patterns, and/or resources may be used to infer sensitivity of lower-level concepts. In an example, business intelligence reports, database views, warehouse cubes, etc. defined over semantic layers may be used to infer the sensitivity of views, tables, and other data elements. Other examples include cloud scopes, ontologies, and implicit containers. Cloud scope may refer to a container or a pod running inside a namespace, which in turn may be provided inside a specific VPC. Implicit containers may refer to, for instance, code packages.

In an embodiment, the processor 202 in conjunction with the context module 212 may be configured to determine the hierarchical context parameter based on associations between the subject entity and one or more higher-level entities identified in the system data. Thus, the hierarchical context parameter may correspond to an attribute relationship of the subject entity with the higher-level entities.

In an embodiment, the processor 202 in conjunction with the context module 212 may be configured to identify contextual peer relationships between the subject entity and one or more peer entities (among the set of entities 120) based on the access logs, data flow traces, source code structures, or visual design artifacts included in the system data.

In an embodiment, the context parameters 312 may include the parallel context parameter 312b. In the parallel context parameter 312b, interactions, co-occurrences, and patterns of access of entities that interact with the subject entity may be utilized to infer the sensitivity of the subject entity. The interactions may refer to joins and subqueries. The co-occurrences may refer to an explicit co-occurrence or an implicit co-occurrence. The explicit co-occurrences may include columns in a table, tables used in view definitions, co-occurrences within codes and tables, features in modeling, etc. The implicit co-occurrences may include, as a non-limiting example, Artificial Intelligence (AI) based clustering.

In an embodiment, the parallel context parameter 312b may be determined by the context module 212 based on the identified contextual peer relationships. Thus, the parallel context parameter 312b indicates a usage-based correlation of the attributes of the subject entity with the one or more peer entities (among the set of entities 120). In an example, the identified contextual peer relationships may be based on:
Data Flow Analysis: Data transformation definitions, lineage, and report definitions may be used to detect co-occurrence and interactions.
Logs: Logs may be analysed to identify co-occurring entities in log messages or queries.
Model Architectures: Feature usage within AI/ML models may be analysed to understand entity relationships.
Data Definitions: Parse table definitions, view definitions, and data partition policies to identify co-occurring entities.
Authorization Policies: Access control rules and authorization policies may be analysed to determine grouping of the one or more entities for access management.
Constraints: Constraints that may indicate relationships between entities may be analysed.
Code Analysis: Parse code to understand entity interactions.
Visual Designs: Colocation, proximity, or interaction-based relation (for example, through links) may be analyzed to discover co-occurring entities. As an example, secure screens or elements used around known sensitive fields may be analysed to identify co-occurring sensitive data elements.
Document Analysis: Co-occurrence of terms in documents may be analysed to infer relationships between entities.
Clustering: Clustering algorithms based on usage patterns, semantic similarity, or storage type similarity may be used to identify implicit co-occurrence patterns.

In an embodiment, the processor 202 in conjunction with the context module 212 may be configured to extract intrinsic attributes of the subject entity from inherent properties such as the metadata, ownership records, encryption policies, or semantic labels of the system data.

In an embodiment, the context parameters 312 may include self-context parameters 312c. In the self-context parameters 312c, the context of the subject entity and/or the resource itself is used to infer the corresponding sensitivity. That is, the inherent context of the subject entity may be considered. The context may include storage class levels and encryption levels.

In an embodiment, the inherent properties may be analysed for the self-context parameter 312c to extract the intrinsic attributes. The inherent properties may include, but not limited to, resource metadata (name, location, permissions, size, creation date, modification timestamp, update frequency, creator and editor attributes like-location, roles, purpose and privileges), storage class, encryption level, user-defined tags or annotations, ownership, access policies, and semantic information (semantically derived meaning and purpose of the data element, derived by NLP based model or ontology-based model). Thus, the self-context parameter 312c is determined based on the extracted intrinsic attributes.

At block 320, the processor 202 in conjunction with the inference module 214 may be configured to infer characteristics based on the context parameters 312, along with spatial, temporal or activity information around the contexts, and determine the entity tags. In an embodiment, the inference module 214 may be configured to model the set of entities 120 and the corresponding relationships in linked representations. The linked representations may include, for instance, the graphical structure.

In an embodiment, the processor 202 in conjunction with the inference module 214 may be configured to generate the graphical structure. The graphical structure may be modelled as linked representations including the nodes and the weighted edges based on modeling contextual relationships between the subject entity and the one or more other entities (among the set of entities 120). In an example, the inference module 214 may be configured to determine the weighted edges based on semantic similarity, interaction frequency, and policy-based relevance. Further, the inference module 214 may be configured to traverse the graphical structure based on a corresponding edge weight and consequently infer the characteristics of the subject entity based on the traversal of the nodes connected to the subject entity in the graphical structure.

The inference module 214 may be configured to identify relevant entity tags for each entity among the set of entities 120 in the graphical structure.

In an embodiment, the processor 202 in conjunction with the inference module 214 may be configured to assign the entity tags based on the characteristics. The inference module 214 may be configured to propagate characteristic values across the graphical structure using the weighted edges, and consequently assign the entity tags to the subject entity based on the propagation.

Once the entity tags are identified, the inference module 214 may define edge weights for the interconnections among the set of entities 120 based on the semantic similarity, the interaction frequency, and the policy-based relevance. That is, the subject entity may be connected with other entities and the weights may define the degree of association or the strength of relationship among the set of entities 120. The inference module 214 may thus be configured to determine the weighted edges (referred to as edge weights). Accordingly, in an example, the edge weights may be determined based on a frequency of interaction between entities, proximity of interaction (used in the same join vs. used somewhere in the query, spatial proximity in a visual design, etc.), access context, usage patterns, semantic similarity, and business-provided rules (business relevance).

In an embodiment, the assigned tags (i.e., the entity tags) may be expressed as probabilistic scores. The propagation using the weighted edges may assist in identifying the characteristics that are not necessarily inherent or apparent. For instance, a timestamp while not inherently sensitive on its own, may be considered sensitive when linked to a sensitive entity (for example, a medical transaction of a patient).

In an embodiment, the inference module 214 may be configured to determine additional tags based on the context parameters 312 and the entity tags. For instance, data sensitivity and confidentiality may be derived based on storage security class or encryption level (for example, higher encryption level may map to high sensitivity), ownership information, access privileges (higher access privilege could map to high sensitivity), historic exposure information of the linked entity or related term in ontology tree (for example, entities linked to SSN or credit card information that has been exposed in various data breaches), and redaction analysis to understand sensitivity (for example, a heavily redacted document may be confidential).

In an embodiment, the set of entities 120 may be virtual entities that may not exist independently in a datastore, however, may be expressed in external elements such as business documents and financial statements. In such a scenario, the entity to tag may not exist prior to tagging. The virtual entities may be mapped to actual entities based on the context. Further, the virtual entities may be tagged based on the external and internal context.

Further, at block 330, the processor 202 in conjunction with the utilization module 216 may be configured to utilize the entity tags in automation of the various tasks 130. In an embodiment, automation workflows may be triggered automatically based on changes in the entity tags and the characteristics. In an embodiment, the utilization module 216 may facilitate automation of the tasks 130 including automated data lifecycle management and storage selection such that retention, archival, replication and other general life cycle events are mapped and automated as per the sensitivity of underlying data.

The tasks 130 may include access control where granular and dynamic access controls may be implemented based on the sensitivity levels and the entity tags. Restrictions may be auto-assigned based on the sensitivity and privileges of associated linked entities. Further, the restrictions may be auto-adjusted based on temporal or event dependent access patterns. Further, policy creation and bundling may be facilitated based on the resource tags to create abstract policies, which reduces the total policy count and additionally enables auto-policy application to elements not defined by their exact identifiers in the policies. Further, the processor 202 in conjunction with the utilization module 216 may be configured to initiate security-data governance actions based on the entity tags. The security-data governance actions may include applying dynamic access control policies, automating data lifecycle events including retention or archival, performing attack surface segmentation, computing data risk scores or task prioritizations, clustering or classifying operational activities, and generating alerts based on sensitivity thresholds, as explained in forthcoming paragraphs.

The tasks 130 may include attack surface reduction that includes sensitivity and tag-based micro-segmentation to isolate sensitive workloads, auto-migration of tasks to secure or privileged environments based on tags, automated data masking, encryption strategy selection, information filtering from specific data feeds or user views for reducing the attack surface for potential data breaches.

The tasks 130 may include scoring and ranking. The ranking may include attack vector ranking wherein attack vector severity may be derived from the weighted sensitivity of elements exposed and adjusted in near real-time based on data movement and sensitivity changes. Further, security tasks and alert prioritization may be facilitated based on the weighted sensitivity of the data sources covered by the task.

The tasks 130 may includes clustering and classification in which the tags may be used as embedding in clustering and classification tasks such as-incident classification and prioritization, access intent classification, etc.

The tasks 130 may include alerting wherein automated security alerts about potential anomalies or unauthorized access attempts involving sensitive data elements may be generated.

In an embodiment, the auto-detection of tags of additional resources may be facilitated using the information derived by the context module 212 and the inference module 214.

Accordingly, a robust and flexible system for data security is provided. The context related to the entities can be considered to develop an accurate representation of the sensitivity of the entities. A comprehensive understanding of data, operational characteristics, and general characteristics (tags) associated with the entities can be developed. Consequently, informed decision-making can be provided and appropriate security measures can be implemented.

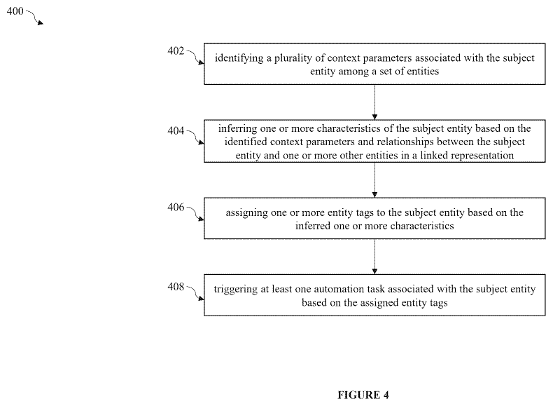

FIG. 4 illustrates a process flow depicting a method 400 associated with the system 110 for automated identification and inference of characteristics of the set of entities 120. The method 400 may be performed by the system 110, in particular, with the processor 202 in conjunction with the modules 210.

At step 402, the method 400 may include identifying the context parameters 312 associated with the subject entity among the set of entities 120.

At step 404, the method 400 may include inferring the characteristics of the subject entity based on the identified context parameters 312 and relationships between the subject entity and one or more other entities within the set of entities 120.

At step 406, the method 400 may include assigning the entity tags to the subject entity based on the inferred characteristics.

At step 408, the method 400 may include triggering the automation task 130 associated with the subject entity based on the assigned entity tags.

It is to be noted that the details involved in the steps of the method have been detailed with reference to FIGS. 1-3 and have not been repeated herein for the sake of brevity.

In an embodiment, the system 110 is provided in a distributed manner, in that, one or more components and/or functionalities of the system 110 are provided through an electronic device, and one or more components and/or functionalities of the system 110 are be provided through a cloud-based unit, such as, a cloud storage or a cloud-based server. In a non-limiting example, the memory 204 may be provided through the cloud storage and the one or more processors 202 may be integrated with an electronic device.

Further, the present invention also contemplates a computer-program product that includes instructions or receives and executes instructions responsive to a propagated signal. Further, the instructions may be transmitted or received over the network via a communication port or interface or using a bus (not shown). The communication port or interface may be a part of the one or more processors 202 or may be a separate component. The communication port may be created in software or may be a physical connection in hardware. The communication port may be configured to connect with the network, external media, the display, or any other components in the system 110. The connection with the network may be a physical connection, such as a wired ethernet connection, or may be established wirelessly. Likewise, the additional connections with other components of the system 110 may be physical or may be established wirelessly. The network may alternatively be directly connected to the bus. For the sake of brevity, the architecture, and standard operations of the memory 204 and the one or more processors 202 are not discussed in detail.

In an embodiment, the computer-program product, having machine-readable instructions stored therein, when executed by one or more processors 202, cause the one or more processors 202 to perform a method as elaborated in subsequent paragraphs at least with reference to FIG. 4.

Further, the present invention also contemplates a non-transitory computer-readable medium encoded with executable instructions. The executable instructions, when executed by one or more processors 202, cause the one or more processors 202 to perform a method as elaborated in subsequent paragraphs at least with reference to FIG. 4. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that the modules, processes, systems, and devices described above can be implemented in hardware, hardware programmed by software, software instruction stored on a non-transitory computer readable medium or a combination of the above. Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

We claim:

1. A method for managing automation tasks for a subject entity, the method comprising:
identifying a plurality of context parameters associated with the subject entity among a set of entities, wherein the plurality of context parameters comprises at least one of a hierarchical context parameter, a parallel context parameter, or a self-context parameter;
inferring one or more characteristics of the subject entity based on the identified plurality of context parameters and relationships between the subject entity and one or more other entities within the set of entities, wherein the one or more characteristics indicate an operational and contextual attributes of the subject entity;
assigning one or more entity tags to the subject entity based on the inferred one or more characteristics, wherein the one or more entity tags indicate a representation of the subject entity's contextual and operational attributes; and
triggering at least one automation task associated with the subject entity based on the assigned one or more entity tags.

2. The method as claimed in claim 1, wherein identifying the plurality of context parameters comprises:
obtaining system data associated with the subject entity, the system data comprising metadata, access logs, data flow traces, source code structures, visual design artifacts, ownership records, encryption policies, and semantic labels;
determining one or more hierarchical context parameters based on associations between the subject entity and one or more higher-level entities identified in the system data, wherein the one or more hierarchical context parameters indicate attribute relationship of the subject entity with the one or more higher-level entities;
identifying contextual peer relationships between the subject entity and one or more peer entities based on the access logs, data flow traces, source code structures, or visual design artifacts of the system data;
determining one or more parallel context parameters based on the identified contextual peer relationships, wherein the one or more parallel context parameters indicate a usage-based correlation of the attributes of the subject entity with the one or more peer entities;
extracting intrinsic attributes of the subject entity from the metadata, ownership records, encryption policies, or semantic labels; and
determining one or more self-context parameters based on the extracted intrinsic attributes.

3. The method as claimed in claim 1, wherein inferring the one or more characteristics of the subject entity comprises:
generating a graphical structure comprising nodes and weighted edges based on modeling contextual relationships between the subject entity and the one or more other entities, wherein each of the weighted edges is based on at least one of semantic similarity, interaction frequency, and policy-based relevance;
traversing the graphical structure based on a corresponding edge weight; and
inferring the one or more characteristics of the subject entity based on the traversal of the nodes connected to the subject entity in the graphical structure.

4. The method as claimed in claim 3, comprising:
assigning the one or more entity tags based on the inferred one or more characteristics, wherein the assignment comprises:
propagating characteristic values across the graphical structure using the weighted edges, and
assigning the one or more entity tags to the subject entity based on the propagation.

5. The method as claimed in claim 4, wherein the one or more entity tags comprises at least one of: sensitivity, volatility, access scope, usage pattern, ownership, relevance, vulnerability, and purpose.

6. The method as claimed in claim 1, wherein the at least one automation task associated with the subject entity comprises:
initiating a security-data governance actions based on the one or more entity tags, wherein the security-data governance actions selected from at least one of
applying dynamic access control policies,
automating data lifecycle events including retention or archival,
performing attack surface segmentation,
computing data risk scores or task prioritizations,
clustering or classifying operational activities, and
generating alerts based on sensitivity thresholds.

7. A system for managing automation tasks for a subject entity, the system comprising:
a memory;
at least one processor in communication with the memory, the at least one processor configured to:
identify a plurality of context parameters associated with the subject entity among a set of entities, wherein the plurality of context parameters comprises at least one of a hierarchical context parameter, a parallel context parameter, or a self-context parameter;
infer one or more characteristics of the subject entity based on the identified plurality of context parameters and relationships between the subject entity and one or more other entities within the set of entities, wherein the one or more characteristics indicate an operational and contextual attributes of the subject entity;
assign one or more entity tags to the subject entity based on the inferred one or more characteristics, wherein the one or more entity tags indicate a representation of the subject entity's contextual and operational attributes; and
trigger at least one automation task associated with the subject entity based on the assigned one or more entity tags.

8. The system as claimed in claim 7, wherein to identify the plurality of context parameters, the at least one processor is configured to:
obtain system data associated with the subject entity, the system data comprising metadata, access logs, data flow traces, source code structures, visual design artifacts, ownership records, encryption policies, and semantic labels;
determine one or more hierarchical context parameters based on associations between the subject entity and one or more higher-level entities identified in the system data, wherein the one or more hierarchical context parameters indicate attribute relationship of the subject entity with the one or more higher-level entities;
identify contextual peer relationships between the subject entity and one or more peer entities based on the access logs, data flow traces, source code structures, or visual design artifacts of the system data;
determine one or more parallel context parameters based on the identified contextual peer relationships, wherein the one or more parallel context parameters indicate a usage-based correlation of the attributes of the subject entity with the one or more peer entities;
extract intrinsic attributes of the subject entity from the metadata, ownership records, encryption policies, or semantic labels; and
determine one or more self-context parameters based on the extracted intrinsic attributes.

9. The system as claimed in claim 7, wherein to infer the one or more characteristics of the subject entity, the at least one processor is configured to:
generating a graphical structure comprising nodes and weighted edges based on modeling contextual relationships between the subject entity and the one or more other entities, wherein each of the weighted edges is based on at least one of semantic similarity, interaction frequency, and policy-based relevance;
traversing the graphical structure based on a corresponding edge weight; and
inferring the one or more characteristics of the subject entity based on the traversal of the nodes connected to the subject entity in the graphical structure.

10. The system as claimed in claim 7, the at least one processor is configured to:
assign the one or more entity tags based on the inferred one or more characteristics, wherein the assignment comprises:
propagate characteristic values across the graphical structure using the weighted edges, and
assign the one or more entity tags to the subject entity based on the propagation.

11. The system as claimed in claim 10, wherein the one or more entity tags comprises at least one of: sensitivity, volatility, access scope, usage pattern, ownership, relevance, vulnerability, and purpose.

12. The system as claimed in claim 7, wherein to trigger the at least one automation task associated with the subject entity, the at least one processor is configured to:
initiate a security-data governance actions based on the one or more entity tags, wherein the security-data governance actions selected from at least one of
apply dynamic access control policies,
automate data lifecycle events including retention or archival,
perform attack surface segmentation,
compute data risk scores or task prioritizations,
cluster or classifying operational activities, and
generate alerts based on sensitivity thresholds.
